(19) United States
(12) Patent Application Publication
(10) Pub. No.: US 2011/0078178 A1
(43) Pub. Date: Mar. 31, 2011

(54) View Server and Method for Providing Specific Data of Objects and/or Object Types

(76) Inventor: Thomas Ehben, Friedeburg (DE)

(21) Appl. No.: 12/890,924

(22) Filed: Sep. 27, 2010

(30) Foreign Application Priority Data
Sep. 29, 2009 (DE) 10 2009 043 456.9
Mar. 17, 2010 (DE) 10 2010 011 664.5

(51) Int. Cl. G06F 17/30

(52) U.S. Cl. 707/769; 707/E17.014

(57) ABSTRACT

A central data server provides data of objects and/or object types. The data are configured as metadata which characterise content available at a site arranged outside a memory of the data server. The data have a validity range and/or a solution space. The contents are uniform within the validity range and/or solution space and are valid for all participants. The data server supplies meta-information in response to a query.

### CROSS REFERENCE TO RELATED APPLICATIONS

This application claims priority of German Patent Application No. 10 2009 043 456.9 DE filed Sep. 29, 2009, and of German Patent Application No. 10 2010 011 664.5 DE filed Mar. 17, 2010. All of the applications are incorporated by reference herein in their entirety.

### FIELD OF INVENTION

The invention relates to a view server and a method for providing specific data on objects and/or object types.

### BACKGROUND OF INVENTION

Complex industrial solutions are characterised by a large amount of information and data, which is required over their life cycle and which must be, or can be, accessed at any time. The life cycle of a plant or an industrial solution covers the implementation of the solution, operation, maintenance, modernisation of the plant, dismantling, etc. The industrial solution business is also characterised by a growing number of participants, for example, manufacturers, subcontractors, operators, service providers, design firms, etc. This means that media discontinuities and ineffective communication between the participants often occur. Media discontinuities take place during cooperation between different participants who do not have access to a common database. Media discontinuities also occur along the life cycle of a solution due to databases not being matched to one another.

This problem is heightened by the increasingly complex collaborations that take place between many service providers over the life cycle, for example, in the domain of the Digital Factory. In this case, advance simulation of complete production plants takes place on the basis of partially abstract technical data on the components that will later be built. The knowledge thereby gained includes, for example, collision identification, throughput estimates, development of maintenance plans and ensuring favourable ergonomics for operating and service personnel.

In the conventional solution, different ways of looking at—or ‘views’ of—objects to be modelled are defined within individual applications. These object views are stand-alone solutions, an example being the design framework Cadence DF II for the development of integrated circuits. ‘Views’ enable the querying of topic-specific or task-specific information for a technical object from different enquiry standpoints. A ‘view’, according to the German version of Wikipedia, printed out in July 2009, is a logical relation in a database system and is also known as a ‘virtual relation’ or a ‘virtual table’. A view essentially represents an alias for a query.

Conventionally, within an organisation there also exist tool-independent, partially text-based and image-based descriptions of proprietary company-internal processes and projects, for example, by means of ARIS.

### SUMMARY OF INVENTION

It is an object of the invention to provide a server and a method which enable complex industrial solutions across the board whilst avoiding media discontinuities.

The aim of the invention is achieved through the features of the independent claims. Advantageous developments of the invention are disclosed in the dependent claims.

An attribute (from the Latin attribuere=give to, assign) is a feature of an actual object stored in the value of a variable. In a programming language, the object is defined by the totality of the attribute values thereof and for each attribute a type is agreed, whilst for the totality of the attributes of similar objects, a class is defined which is therefore a pattern for all objects having the same features or, in the realisation, is a pattern for the storage of the variable feature values for all actual objects that are typified by the class. The object is addressed by a reference and the attribute value is reached by addressing the reference of the actual object plus selecting the attribute according to the class definition. File attributes are understood to be various details concerning a computer file which do not belong directly to the actual content of the file.

A view is a logical relation in a database system, also called a virtual relation or a virtual table. This logical relation is defined by a query stored in the database management system (DBMS). Whenever a query uses this view, it is first calculated by the database management system. A view essentially represents an alias for a query. A view server supplies, in manufacturer-independent manner, the types and available views of the instances depending on the instance ID, as expressed below with the relation or function Type=Type(Object-ID).

A method is understood, in the field of object-oriented programming, to be a construct which defines the behaviour of objects.

Formally, in information technology, a data type is the grouping together of object sets together with the operations that can be performed on them. By means of the data type of the data set, using a ‘signature’, only the names of these object sets and operation sets are specified. A data type specified in this way does not yet have any semantics.

Service-oriented architecture (SOA) is an approach in information technology in the field of distributed systems, in order to structure and use the services of employees and organisations. A particular role is played by the orientation toward business processes of which the abstraction layers are the basis for concrete service implementations.

Unified Modeling Language, or UML, is a language developed and standardised by the Object Management Group (OMG) for modelling software and other systems. This is also standardised by the ISO (ISO/IEC 19501). As a language, UML defines identifiers for most of the important terms used for modelling and stipulates possible relationships between these terms. UML also defined graphical notations for these terms and for models of static structures and dynamic processes that can be formulated with these terms.

The term Radio Frequency Identification (RFID) denotes identification with the aid of electromagnetic waves. RFID enables automatic identification and/or localisation of objects and living beings and thus significantly facilitates the recording and storing of data.

Extensible Markup Language, or XML, is a mark-up language for representing hierarchically structured data in the form of text data. XML is used, inter alia, for the exchange of data between computer systems, in particular via the internet.

SQL is the abbreviation for Structured Query Language, which is a database language for defining, querying and manipulating data in relational databases. SQL is standardised by ANSI and ISO and is supported by almost all commonly used database systems.

The Web Services (WS)-Business Process Execution Language (BPEL) is an XML-based language for describing business processes whose individual activities are implemented by web services.

The view server for providing specific data on objects and/or object types contains data which are configured as metadata which characterise content available at a site arranged outside the memory of the server. The data have a validity range and/or solution space within which they are uniform and preferably are valid for all units accessing the solution space.

Preferably, the data format and the exchange protocol of the data are uniformly standardised for a validity range and a solution space.

A query (input) to the view server preferably contains an object ID, a type, a view and/or an attribute, and the respective response from the server (Output(Input)) contains a “Type(Object ID)”, a “View(Type)”, “Attribute(View)”, a “Data type(Attribute)”, a “Value range(Attribute)”, “Services(View)”, “Services(Type)” and/or a “Methods(View)”.

The solution space preferably represents or images:
a building site,
a project,
a plant for the region of which a set of object data is agreed and standardised,
a business group,
a consortium which uses object data for a plurality of projects, and/or
an industry and/or sector and/or domain which uses uniform data standards worldwide, and/or worldwide standardised data.

Actual data contents, for example, values of the attributes and services are kept outside the view server.

The view server preferably supplies meta-information which specifies and characterises the detailed data.

Preferably the detailed data/data types that are stored in the server, for example, elementary components, plants, subsystems (steam turbine), complete plants (generating stations), machines, e.g. industrial robots, goods containers, e.g. 40-foot ISO containers. In particular, the definitions of manufacturer-specific views/object types and attributes and services for views are included.

The server preferably builds upon conventional databases, for example, SQL servers, wherein the data exchange preferably takes place with the metaformat XML and via the internet wherein the server can be accessed, for example, during the engineering phase of a solution, during the rough engineering, e.g. feasibility studies, offer phases, detailed engineering including project development, construction site, component engineering.

During operation of a solution of a solution space, queries are carried out manually, for example, by service technicians for maintenance operations, or automatically, for example, by querying the operating costs via a BPEL script.

Preferably, the solution with the server is suitable for a logistics chain. An object, for example a goods item, knows its location, for example, the ID of the site in the shelving system, and the object (the goods item) determines the ID of the associated distribution store in which the shelving system is situated, preferably in that the object (the goods) queries a service of the shelving system, whose existence the object (the goods) has queried from the server (S),
wherein the object (the goods) queries the shippers associated with the distribution store,
wherein the object (the goods) queries the shipping conditions of the shippers via registered services,
wherein the object (the goods) instigates its own collection by a shipper of its choice,
wherein the object (the goods) identifies and selects, via other instances, its further route,
wherein it accesses each station of its route on the server.

Preferably, the object ID of an object required for access to the server is stored on an RFID tag, which is physically connected to the object, so that a person or another object can query object data regarding an object by accessing the server.

Preferably, accepted standards are coupled to one another, for example, Digital Factory, SOA, type/instance model, behaviour and structure description, for example, with UML Internet of Things, RFID, XML, SQL.

The standards for structuring and transferring the metadata in the server are defined by an authority mandated for the respective solution space, for example, for the issuing of ID-address spaces.

Preferably, in order to provide specific data, the descriptions or metafiles that are available relating to an object and/or an object type are supplied by the view server following a query, and the actual physical and logical data or content of object types to be modelled are retrieved by the server from separate databases lying outside the view server, in particular databases of the component or system manufacturer.

The modelling, simulation and optimisation of systems and plants are also supported. For a modelling or a simulation, descriptions (metafiles) of an object or an object type that are available can be queried by the server. The actual physical and logical data of object types to be modelled can then be retrieved from separate databases of the component manufacturer or system manufacturer.

Therefore, manufacturer-independent modelling of digital factories and plants is facilitated. Modelling, simulation and optimisation are supported in that the relevant data scope for modelling and the presence of data required for modelling can be queried.

Implementation and operation of industrial solutions in the real world can be made more efficient than now. Worldwide and across different sectors, a standard for the exchange of data concerning technological objects can be defined, administered and applied.

The invention facilitates investment business by coupling worldwide accepted standards, some of which are long established, and paradigms such as
Digital Factory
SOA
Type model/instance model
Behaviour and structure description, e.g. with UML
Internet of Things
RFID
XML
SQL

### BRIEF DESCRIPTION OF THE DRAWINGS

The invention will now be described in greater detail making reference to the drawing, in which:

FIG. 1 shows a schematic overview of the server for providing specific data

### DETAILED DESCRIPTION OF INVENTION

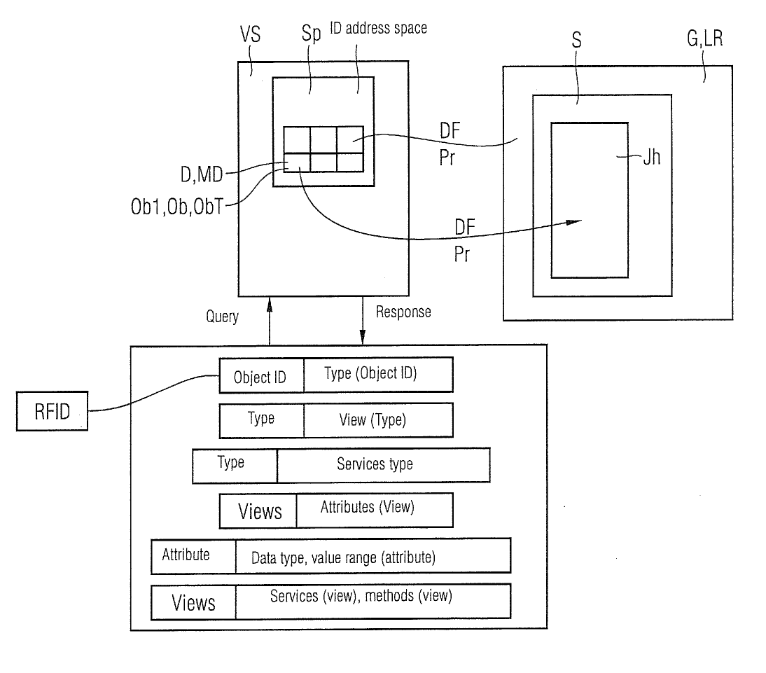

FIG. 1 shows a server S for providing specific data on objects Ob and/or object types ObT, wherein the data D are configured as metadata MD which, at a site arranged outside the memory Sp of the server S, characterise the available content Ih. The data D have a validity range G and/or a solution space LR, within which they are uniform and preferably valid for all units accessing the solution space LR.

The data format DF of the data D, MD and the exchange protocol Pr of the data D, MD are uniformly standardised for a validity range G or solution space LR in each case.

Each validity range G or solution space LR is imaged by a server S.

A query “Input” to the view server VS comprises an object ID, a type, a view and/or an attribute. The response from the view server (Output(Input)) comprises a “Type(Object ID)”, a “View Type)”, an “Attribute(View)”, a “Data type(Attribute)”, a “Value range(Attribute)”, “Services(View)” “Services(Type)” and/or “Methods(View)”.

The solution space LR can image or represent
a construction site,
a project,
a plant for the region of which a set of object data Obd is agreed and standardised,
a business group,
a consortium which uses object data for a plurality of projects, and/or
an industry and/or sector which uses uniform data standards worldwide, and/or worldwide standardised data.

Actual data contents, for example, values of the attributes “Attribute(View)” and services “Service(View)”, are held outside the view server VS. The view server VS supplies meta-information, which specifies and characterises the detailed data.

The detailed data/types that are stored in the server S contain, for example, elementary components, plants, subsystems (steam turbine), complete plants (generating stations), machines, e.g. industrial robots, goods containers, e.g. 40-foot ISO containers. In particular, the definition of manufacturer-specific views/object types and attributes and services for views are included.

The view server VS is built upon conventional databases, for example, SQL servers. Data exchange preferably takes place in the metaformat XML and via the internet, wherein accesses to the view server S can take place, for example, during the engineering phase of a solution, during the rough engineering, e.g. feasibility studies, offer phases, detailed engineering including project development, construction site, component engineering.

The object ID of an object required for access to the view server VS is present, for example, on an RFID tag RFID, which is physically connected to the object, so that a person or another object Ob1 can retrieve object data on the object Ob by accessing the view server VS.

The standards for structuring and transferring the metadata MD in the view server VS are defined by an authority mandated for the respective solution space, for example, the issuing of ID-address spaces.

The available descriptions or metafiles MD of an object Ob and/or of an object type ObT are supplied (Response) by the view server VS following a query. The actual physical and logical data or content (Ih) is retrieved for object types to be modelled in separate databases outside the view server VS, particularly those of the component or system manufacturers.

1.-13. (canceled)

14. A view server for providing data of objects and/or object types, comprising:
a memory,
wherein the data are configured as metadata which characterize contents available at a site arranged outside the memory of the view server, and
wherein the contents include a validity range and/or solution space, the contents being uniform within the validity range and/or solution space.

15. The view server as claimed in claim 14, wherein, within the validity range and/or solution space, the contents are valid for all units accessing the solution space.

16. The view server as claimed in claim 14, wherein a data format and an exchange protocol of the data describe a validity range and/or a solution space which is defined for further data.

17. The view server as claimed in claim 14, wherein
a query (input) to the view server contains an object ID, a type, a view and/or an attribute, and
a response from the view server (output) contains a “type(object ID)”, a “view(type)”, an “attribute(view)”, a “data type(attribute)”, a “value range(attribute)”, “services(view)”, “services(type)” and/or “methods(view)”.

18. The view server as claimed in claim 14, wherein the solution space represents:
a construction site,
a project,
a plant for the region of which a set of object data is agreed and standardised,
a business group,
a consortium which uses object data for a plurality of projects, and/or
an industry and/or sector which uses uniform data standards worldwide, and/or worldwide standardised data.

19. The view server as claimed in claim 16, wherein the further data comprise values of attributes and services, and wherein the further data are kept outside the view server.

20. The view server as claimed in claim 16, wherein the view server supplies meta-information which specifies and characterises the further data.

21. The view server as claimed in claim 16, wherein the further data and/or data types are stored in a server outside the view server.

22. The view server as claimed in claim 21,
wherein the further data and/or data types comprise elementary components, plants, subsystems, e.g. a steam turbine, complete plants, e.g. a generating station, machines, e.g. industrial robots and/or goods containers, e.g. 40-foot ISO containers, and
wherein a definition of manufacturer-specific views/object types and attributes and services for views are included.

23. The view server as claimed in claim 14,
wherein the view server is based upon conventional databases,
wherein a data exchange takes place with a meta-format XML and via the internet,
wherein the view server can be accessed during an engineering phase of a solution, during rough engineering, e.g. feasibility studies, offer phases, during detailed engineering including project development, construction or component engineering.

24. The view server as claimed in claim 23, wherein the view server is based upon a SQL server.

25. The view server as claimed in claim 17, wherein, during operation of a solution of a solution space, the view server can be queried by querying operating costs using a BPEL script.

26. The view server as claimed in claim 25, wherein the view server is queried by querying operating costs when necessary maintenance operations are performed.

27. The view server as claimed in claim 17, wherein the object ID of an object required for access to the view server is stored on an RFID tag physically connected to the object so that a person or another object can query the data configured as metadata regarding the object by accessing the view server.

28. The view server as claimed in claim 14, wherein accepted standards are coupled to one another.

29. The view server as claimed in claim 28, wherein Digital Factory, SOA, type/instance model, behaviour and structure description are coupled with UML Internet of Things, RFID, XML, SQL.

30. The view server as claimed in claim 14, wherein standards for structuring and transferring the data configured as metadata on the view server are defined by an authority mandated for the respective solution space.

31. The view server as claimed in claim 30, wherein issuing of ID-address spaces is defined by the authority mandated for the respective solution space.

32. A method for providing data of objects and/or object types, comprising:
using a view server;
sending a query to the view server, the query relating to data of an object and/or object type;
supplying the data by the view server following the query; and
retrieving further data by the view server from separate databases lying outside the view server.

33. The method as claimed in claim 32,
wherein the query relates to descriptions or metafiles relating to the object and/or object type,
wherein the further data comprise actual physical and logical data or contents of object types to be modelled, and
wherein the further data are retrieved from databases of a component manufacturer or system manufacturer.
